(19) United States
(12) Patent Application Publication
(10) Pub. No.: US 2006/0112073 A1
(43) Pub. Date: May 25, 2006

(54) Interface building/design tool for generating nested interface systems and displays

(76) Inventors: David L. Jensen, Peekskill, NY (US); Ildar Khabibrakhmanov, Syosset, NY (US); Prince J. Stanley, Croton-On-Hudson, NY (US); Emmanuel Yashchin, Yorktown Heights, NY (US)

Correspondence Address: Whitham, Curtis & Christofferson, P.C., Suite 340, 11491 Sunset Hills Road, Reston, VA, 20190, US

(21) Appl. No.: 10/992,948

(22) Filed: Nov. 22, 2004

(51) Int. Cl. G06F 17/30

(52) U.S. Cl. 707/2

(57) ABSTRACT

Design and deployment of an interface for a data processing application is facilitated by a tool, preferably implemented in software, which parses a description of data to form a hierarchy of groups of selector, terminal and intermediate attributes, including generation of attributes through specification of analyses of data, to develop an interface building program which, when executed, builds an interface for the data processing application. The attributes of the hierarchy are configured into layers, analyses are selected and/or specified, interface display pages are configured and global controls are specified using the tool. Markers having freely definable visual attributes and properties corresponding to analysis results such as return codes provide a condensed display which also facilitates access to data nested beneath each marker.

### BACKGROUND OF THE INVENTION

1. Field of the Invention

The present invention generally relates to user interfaces for computer systems and, more particularly, to tools for generating special purpose interfaces for monitoring large numbers of processes and databases.

2. Description of the Prior Art

It has long been recognized that while computers can monitor and manage massive amounts of data and large numbers of concurrent processes, their utility is ultimately limited by the amount of information that can be communicated to and assimilated by a user. Therefore, substantial design effort, hardware and processing time of the computer is often dedicated to presenting information by means of a user interface that will allow efficient interaction between the user and the applications run on the computer. For this purpose, displays are often included to rapidly present results of data processing by the computer as well as providing additional instrumentalities such as menus, tool bars, cursors, touch screens and the like for additional convenience of user input and control. Such displays and additional features are often collectively referred to as a graphic user interface (GUI).

The limitations on practical physical size of displays as well as practical limitations on the amount of information that can be quickly assimilated by a user impose substantial restrictions on the amount of information which can be represented by a GUI at any given time. That is, important information should not be obscured in the “clutter” of an image containing an excessive amount of information and the user's assimilation of the information should not be slowed by a need to closely inspect particular regions of the image or screen in order to locate information of interest. In this regard, numerous visual effects such as blinking or alteration of color, brightness or contrast are known for highlighting of information to draw a user's attention to particular displayed information. Further, information is often displayed in a hierarchical form with sequentially increasing degrees of detail and accessed through menus or the like which are similarly hierarchical in order to limit the amount of information displayed at a given time and to allow the user to quickly find information of interest in a simple, convenient and intuitive manner.

The often substantial cost of development of interfaces can usually be amortized over many copies of commercially distributed software such as word processors, spreadsheets and the like. Further, much commercially distributed software does not require particularly complex or highly customized interfaces. However, for manufacturing environments and the like, the software developed may be unique to a single customer type of process and/or database environment and be much more complex; involving massive amounts of data and simultaneous monitoring of numerous diverse processes. For example, in monitoring of warranty data for complex machines such as computers, the machines as delivered to customers will generally carry a warranty from the manufacturer of the machine. Failures will generally involve the replacement of assemblies of parts referred to as field replaceable units (FRUs) and many components included therein may also carry a warranty from a supplier. The types and frequencies of failures of any of potentially thousands of parts must be closely tracked among both customers (and the environments in which products will be used by such customers) and suppliers in order to ensure that products sold will be adequately reliable and that costs of repairs under warranty do not unduly compromise profits. Often, other complex analyses of failures must also be made.

Therefore, the interface must often be unique to the application and may be much more complex than interfaces for most commercially available software. It is not unusual for the design and development of a custom interface for a complex application to consume one-half programmer-years at a cost of one hundred thousand dollars or more. Moreover, a high degree of familiarity with the application and its environment is generally required for development and testing of an appropriate interface and often limits the number of programmers that can efficiently and productively work on the interface in order to minimize overall development time. Further, such work often cannot be started until a substantial portion of the application is developed, delaying implementation of the application by weeks or months.

### SUMMARY OF THE INVENTION

It is therefore an object of the present invention to provide a tool for the development of a user interface for software applications.

It is another object of the invention to provide partially condensed displays for improving user assimilation of presented data and facilitating the production of analyses and the location of information of interest.

In order to accomplish these and other objects of the invention, a method of creating an interface for an arbitrary application program is provided or a computer readable storage medium containing a program which, when run, comprises steps of parsing a description of data to determine attributes of a plurality of objects, partitioning said attributes into groups, establishing a hierarchy among attributes of at least one said group of attributes, providing analysis formulas for computing values of attributes from attributes lower in said hierarchy, and establishing visual characteristics of markers corresponding to values resulting from said computing of values in accordance with said formula.

In accordance with another aspect of the invention, a computerized interface building tool including an arrangement for parsing descriptions of data to be managed by an application through use of said interface to develop a categorization and hierarchy for attributes of said data as defined by said descriptions, an arrangement for defining analyses of data in accordance with said categorization and hierarchy, an arrangement for defining visual attributes and properties of markers of a display, and an arrangement for outputting said categorization, hierarchy, analyses and properties to derive an interface building program.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a high-level block diagram/flow chart illustrating a general overview of the invention,

FIGS. 2 and 3 illustrate exemplary interface screens such as may be produced by the invention,

FIG. 4 is a schematic representation of a preferred embodiment of the invention detailing the overview of FIG. 1,

FIG. 5 is a detailed schematic depiction of the page configuration module in accordance with a preferred embodiment of the invention, and

FIG. 6 is a schematic depiction of deployment of the invention.

### DETAILED DESCRIPTION OF A PREFERRED EMBODIMENT OF THE INVENTION

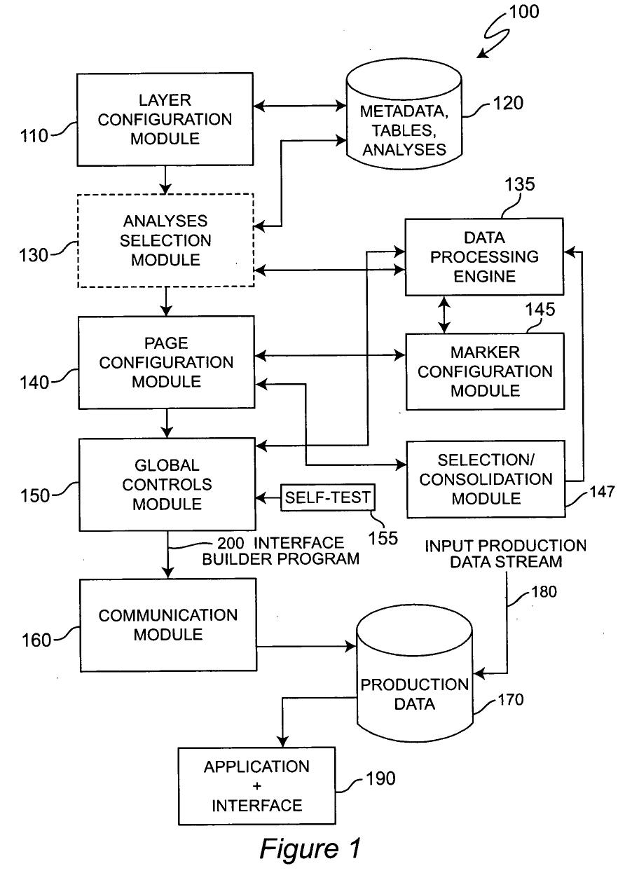

Referring now to the drawings, and more particularly to FIG. 1, there is shown a high level schematic diagram of the basic elements of an interface building tool (IBT) 100, sometimes referred to as an Interface Development or Design Tool (IDT), in accordance with the basic principles of the invention. It will be understood by those skilled in the art that, at the level of abstraction represented in FIG. 1, that FIG. 1 can also be understood as a flow chart illustrating the method employed by the interface building tool in accordance with the invention. It will be helpful to bear in mind during the following discussion that the invention is a tool which facilitates the design of an interface by a designer and reduces the burden on the interface designer in developing a custom interface for a complex application which will nevertheless be flexibly usable by an end user of the interface, itself. Therefore, while it is necessary to concurrently discuss both the facilities and capabilities of the interface ultimately developed for the end user of the interface and the facilities and capabilities of the interface building tool (IBT) in accordance with the invention as used by a designer or user of the IBT, the distinction between them should be closely observed. It will also be helpful during the following discussion to consider the invention as a (preferably software) tool for generating process parameters which when inserted into or processed in accordance with another program (e.g. similar to a compiler) generates an interface building program (IBP) which, in turn, when run in the course of deployment of the interface, builds the code for implementing the interface. The magnitude of reduction of interface designer burden and time, ease of specification of analyses by a designer, the ease of manipulation and grouping of data for analysis by the end user through the resulting interface and the high degree of automation of the development of the interface makes the invention practical for convenient and informative viewing of any body of existing data (e.g. for exploratory data analysis) and thus need not necessarily be implemented with a monitoring system or the like; in connection with which the invention will be discussed below.

It is an important feature of the invention that the invention is intended to operate on only a description of the data which will be processed by the application for which the interface is built, as distinguished from operating on actual or exemplary data. Such a description of data is referred to as “metadata” and that term will be used from time-to-time hereinafter. Such metadata should, of course, be consistent with descriptions of data and actual data being processed in any applications to be managed by the (custom) application or providing input thereto. While the invention could operate on actual or exemplary data, the capability of operating on only metadata descriptions thereof is considered to be an important advantage of the invention since metadata descriptions can easily reflect all the important facets of the data set without the production of a single data record while, in contrast, actual or exemplary data may be much too limited to reflect various possibilities of data relationships which may prove to be of importance or interest.

It is assumed, for purposes of the following description of the invention, that the application for which the interface will be built by the invention provides, possibly through a potentially large number of other applications, information concerning a set of basic units. Such basic units can correspond to any physical object, device or material (including plant or animal tissue) or any conceptual construct having associated data. Since the principal preferred (and exemplary, for purposes of explanation of the invention) environment for the invention is in regard to an application for monitoring condition, use, repair history, performance and warranty information, in regard to manufactured products and components thereof, it will be convenient and helpful to better convey an understanding of the invention to refer to such basic units as “parts”. Every such part is characterized by a set of attributes which may include generic part characteristics, part-specific characteristics, methods of data processing applied to obtain information about the part and types and methods of analysis of the collected data and the like. In general, attributes may be understood in much the same manner as the term attributes is used in so-called object oriented programming.

For example, in the assumed environment of a custom application where it is desired to track field performance of every part which is included in various machine types, generic attributes of a part may include its type, (e.g. a hard drive for a computer), brand (e.g. supplier), geography (e.g. location of the manufacturing facility for the part), machine type, part number and the like. Assuming the part is, in fact, a hard disc, part-specific attributes for the part could include, for example, operating speed (e.g. disc RPM), presence or absence of a slot for a secondary drive, type of bearings used in the drive, serial number and the like. Methods of processing or analysis could be, for example, construction of a table where rows correspond to number of drives shipped, warranty start date, identification of a customer that received the drive, indication (yes/no) of a failure, type of failure and the like. Alternatively or additionally, a method of processing might be construction of a table where rows correspond to machines in which a hard drive was shipped, machine serial numbers, model type and number of hard drives included in the machine. Another method of analysis might be a graphical representation such as mean time to failure of parts from different suppliers, geography, warranty start date and the like or statistical analyses such as histograms with data sorted in different ways.

Preferably, the invention is arranged to operate from a table, relational database or the like that contains data relevant to various analyses or reports which are of interest or contemplated for processing by the application. For example, actual data included in such a table and the organization thereof might be:

| | |
|---|---|
| Brand: | Mobile |
| Component: | Hard Drive |
| Geography: | US |
| Machine Type: | 5566 |
| FRU: | 12P3456 |
| Part Number: | 74N4321 |
| Technology: | T125 |
| Customer Type: | Banking |
| Type of Analysis: | S123456 |
| Data Processing Method: | M123 |
| Return Code: | 12 |
| No. of Parts: | 12000 |
| No. of Fails | 32 |
| Vintage Range: | 2003-12-20/2004-05-26 |
| Link to Table: | w3.company.com\tables\tab1.txt |
| Link to Plot: | w3.company.com\plots\plot1.gif |

It should be understood and appreciated that the right-hand column of the above table contains actual (or simulated actual or exemplary data. It should also be noted that this table gives a summary of analyses performed by a data processing engine (DPE), details of which are otherwise unimportant to the invention, in relation to performance of hard drives in mobile devices (e.g. Personal Digital Assistants (PDAs) and the like, in the US geography. The records in the table specify the actual machine type, FRU, part number and technology (e.g. multi-platter with magneto-resistive heads) for which the analyses were performed (e.g. robust regression) and which would specify, for example, sorting and consolidation used in each such analysis (if more than one analysis is performed for a given record) and specifies the return code (RC) that characterizes the assessment of the result of each analysis corresponding to this record. In general, the value of a return code will be arranged to indicate how interesting the analysis is or should be to the end user and can be a vector or more complex data structure. For example, RC=0 could indicate that an analysis result was within nominal limits and did not give any reason for suspicion; RC=12 could be decoded to to provide specific reasons for any suspicion of abnormality or reason for user interest based on the thirty-two reported fails among twelve thousand drives in the vintage range shown in the table. The links provide additional graphical and tabular support regarding any such suspicions. Other return codes could indicate, for example, a confidence level that data at a lower hierarchical level or consolidated with other data in the analysis will be significant. In summary, either data, analyses or return codes can be used to control visual attributes of markers either directly or indirectly in a manner which can be freely defined and which may assist an end-user in navigating through the interface in a manner which is substantially intuitive to locate data of interest or which may seem to have an increased likelihood of being of interest.

More generally, a table expressed in terms of data descriptions or metadata upon which the invention preferably operates would be, for example:

| | |
|---|---|
| Brand: | Char(16), categorical |
| Component: | Char(18), categorical |
| Geography: | Char(4) |
| Machine Type: | Integer(4), WildcardOK |
| FRU: | Char(7), categorical, WildcardOK |
| Part Number: | Char(7), categorical |
| Technology: | Char(4) |
| Customer Type: | Char(16), categorical |
| Type of Analysis: | Char(7), categorical |
| Data Processing Method: | Char(4), categorical |
| Return Code: | Integer(4) |
| No. of Parts: | Integer(8) |
| No. of Fails | Integer(8) |
| Vintage Range: | Datebegin, “/”, Dateend |
| Link to Table: | URL |
| Link to Plot: | URL |

It should be noted that, in practical situations, it is considered preferable to provide for wildcard symbols (e.g. “*” or “?” such that, for example, if the FRU field contained “*” the analysis would pertain to all FRUs) in fields, as indicated by “WildcardOK” in the above table. “Categorical” indicates anticipation of one or more distinct categories of entry rather than an arbitrary character or integer sting of a maximum length, as indicated by Char(n) or Integer(n). It should also be noted that the number of fields provided is arbitrary and may be much larger than in the above example. From the latter table, above, it can be seen that the left column of the table and the right column, as well, to the extent it includes database management information such as format constraints and the like, constitutes a description of anticipated data, as distinguished from actual data regarding parts and constituting its attributes (e.g. as provided in the former table), and is thus metadata on which the invention operates. That is, the latter table provides a description which is similar to a description of variables and structures in languages such as C++ or XML. Many such tables may be presented for each of the many parts and many assemblies of parts (e.g. FRUs) of many different products which may be monitored by the (custom) application for which the invention creates/provides an interface. When the IBT in accordance with the invention is activated, resulting in an interface building program (IBP) and then the IBP is activated on a UNIX™ machine or the like to produce the actual interface, the interface then obtains access to the actual data such as is specified in the former table, above, as will be discussed in greated detail below. Thus, the IBP can be viewed as a pre-compiled version of the interface obtained based on specification developed under control of the interface building or development tool (IBT/IDT) in accordance with the invention.

Returning now to FIG. 1, the organization and operation of the invention will now be described. The fact that metadata is used by the invention independently of actual data is an important feature of the invention as mentioned above, since the construction of the interface may be performed and testing carried out immediately upon determination and description of the data which the application should accommodate and which generally already exists in the respective applications to be managed. Changes in the data accommodated or its descriptions can easily be implemented automatically and the results tested well before actual data exists and thus the interface may be completed, tested and ready for implementation upon completion of the custom application. Nevertheless, it should be understood that the invention is preferably capable of operating on actual data, as well, by extracting generalized descriptions from such actual data in a manner well-understood in the art. Again, however, operation on actual or exemplary data is not preferred for the simple reason that the such actual or exemplary data, even if of large volume, may not support a full generalization of descriptions of data commensurate with the metadata that should be available in accordance with the applications to be accommodated by the (custom) software for which the invention facilitates providing an interface.

To develop the interface, the invention is preferably implemented as a group of modules; preferred forms of which will be described in greater detail below. For example, to summarize data so as to detect that a particular part is exhibiting an abnormal (e.g. less than acceptable reliability) in the field, the layer configuration module 110 obtains metadata or, possibly, actual or exemplary data), preferably in the form of tables as described above, from storage 120 and parses it to determine a hierarchy among parts and to partition the attributes into groups by assigning categories to attributes, establishing groups of attributes that determine layers and establishing a hierarchy of layers. In the course of doing so, the groups of attributes are preferably categorized into three attribute categories which will function differently in regard to operation of the interface to be constructed by the invention. These categories are preferably:

Selector attributes which are under the direct control of the interface user for control of display presentation of information (e.g. a user can freely designate Geography or Type of Analysis or other attributes, as noted in the above table, to be such selector attributes);

Terminal attributes which are properties that serve as a basis of decisions related to a part and determine the outcomes or results of the analyses such as return codes (RC), outcome tables, plots, reports or decisions which are incorporated in displays or the like through properties of markers and triggers (e.g. the ultimate information provided by a record, although other information could be nested below it); and

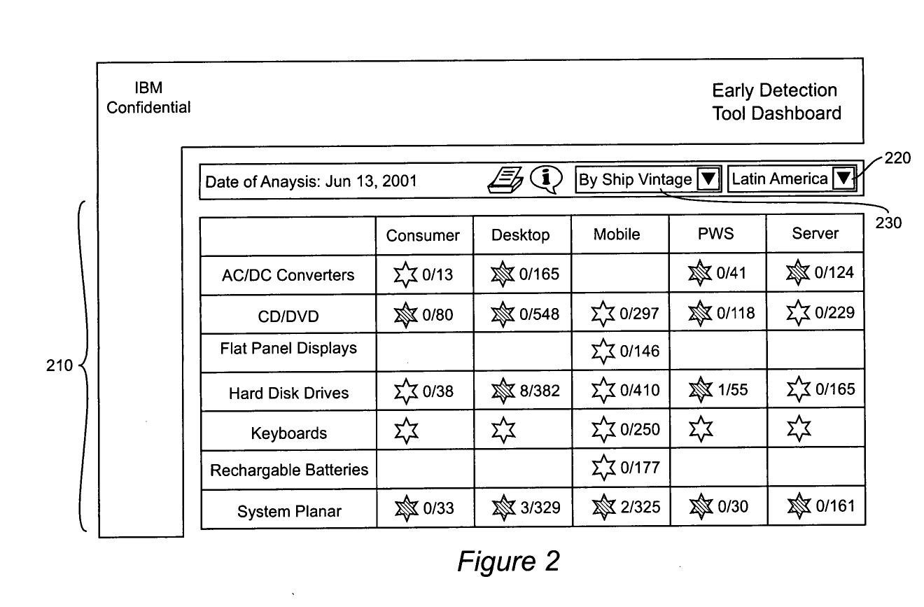

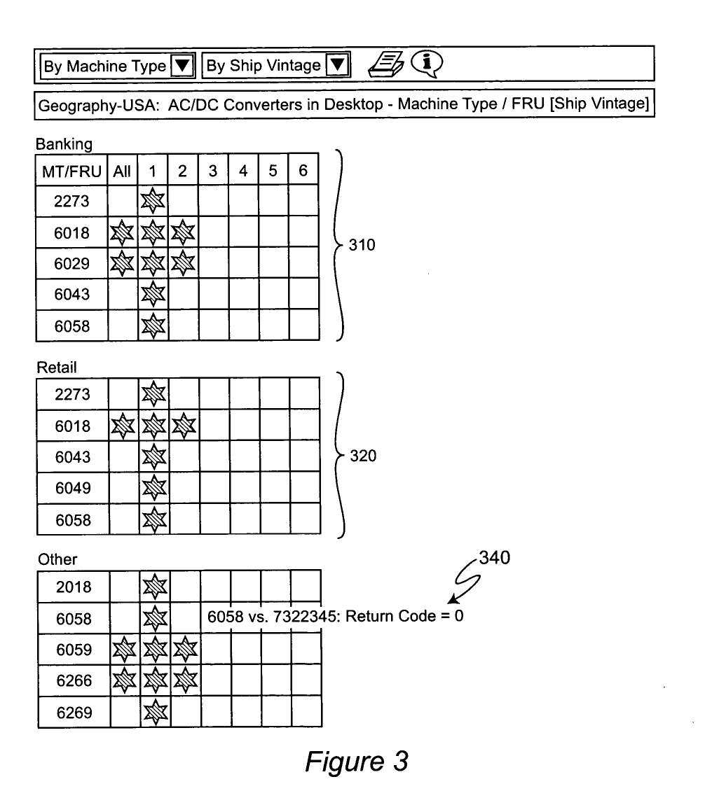

Intermediate attributes which are organized in groups and serve as a basis of two-dimensional (e.g. partially condensed) display pages, as will be described in greater detail below. These categories may be conceptualized as a tree-like hierarchy, also developed by the layer configuration module, with the selector attributes as root nodes, terminal attributes as leaf nodes and intermediate nodes as branching nodes. For example, the combination of “Brand” and “Component” attributes correspond to a first level of a hierarchy, a triplet of “customer type”, “machine type” and “FRU” correspond to a second hierarchy level, and so on. The hierarchy thus developed thus corresponds to parts, sub-combinations of parts which, in turn, form larger combinations of parts and so on until FRUs and the entire unit are represented by respective hierarchy levels or layers. (It will be helpful to observe that FIG. 2 corresponds to the first layer of brand-component combination of attributes and FIG. 3 corresponds to the customer type-machine type-FRU triplet combination of attributes.)

The layer configuration module 110 enables the hierarchy to be specified by a user. However, a user-specified hierarchy may not be feasible. For example, in the exemplary attribute assignment discussed above, it is assumed that an analysis of any customer type-machine type-FRU triplet will be available in the list of analyses for any given pair of brand and component attributes when the selection attributes are at some fixed levels which is not necessarily the case. That is, the selector attributes are on fixed levels such as Geo=USA could be a fixed level of a selector attribute exposed to end-user control for which analyses such as those alluded to above are expected to be available. However, such analyses may not necessarily be available for a user-specified hierarchy. Therefore, checking of the feasibility of the hierarchy and a mechanism to achieve feasible layer configurations is preferably provided as will be described below. Preferably, a help facility is provided to enable a user to scan a list of available analyses and suggest feasible layer configurations which can be chosen by the interface designer.

For example, the scanning of a list of available analyses will establish that analyses are available for any selected “Geo” attribute and within this Geo by brand and component attributes and for any combination of brand and component combination, analyses are available for any triplet of customer type, machine type and FRU, preferably by using an algorithm for determining the structure of the collection of analyses provided; the details of which are not important to the understanding or practice of the invention in accordance with its basic principles. In general, available analyses will be provided for one or more triple combinations under one or more of a plurality of doublet combinations under one or more of a plurality of selection attributes; each available combination being displayable to a user for selection responsive to user specification of a hierarchy which does not correspond to an available analysis. In general, however, the designer will know in advance from the metadata what analyses are present in the list and will thus be able to categorize attributes and create a level hierarchy based thereon.

Every member of each group of attributes is preferably associated with a marker object which may have any number of graphical properties such as a shape, a color or other visual attributes such as blinking as alluded to above, a tool tip (similar to a so-called bubble help legend), associated text, comment, set of possible actions (e.g. implemented as a pull-down menu or the like), associated vector of values, pre-specified user responses (e.g. single- or double-click, visibility flags (e.g. if some properties of the marker that reflect the state of a particular marker are to be actually displayed on a page of the interface and/or use of background color and intensity control for additional analysis result information and which can cause a marker shape to become invisible or of different contrast), and the like. Some of the properties of a marker are displayed on the display screen or other interface device. The layer configuration module thus establishes a hierarchical structure between various groups of attributes.

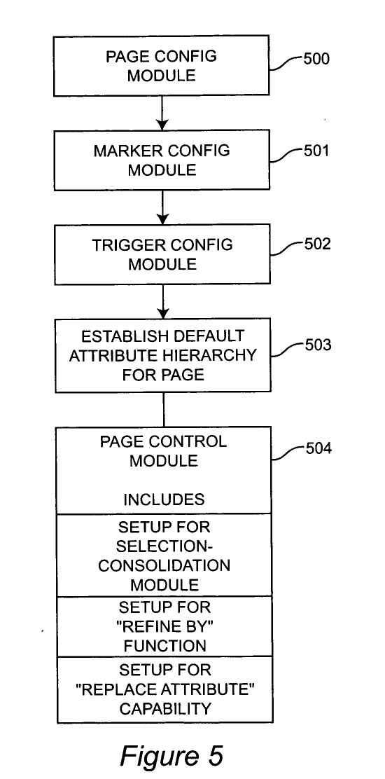

The analyses selection module 130 receives these groups of attributes and data and selects algorithms to be applied to data by data processing engine (DPE) 135 for particular reports anticipated to be desirable and which are preferably resident in the DPE 135. Details of these algorithms and DPE 135 are not important to the practice of the invention and will usually be arranged to reflect the types of data in the tables discussed above. Some of these algorithms may be automatically pre-computed in anticipation of a user request upon receipt of new data which is included in the computation. The results are then preferably stored in memory 120 as attributes or links thereto (e.g. Link to table, Link to plot in the above described table) from which they may be rapidly recalled. Other analyses which may not be anticipated or which are less computationally intensive or can be estimated with adequate accuracy (e.g. by averaging) can be selected and computed on-the-fly in order to avoid excessive consumption of storage space and computational overhead in maintaining current analysis results. Thus, the analyses selector module controls transfer of data descriptions including analysis algorithms and links thereto to the page configuration module 140 which will now be generally described. A more fully detailed description will be provided below in connection with FIG. 5.

Basically, the page configuration module 140 focuses on a given group of attributes which constitutes a layer defined previously by the layer configuration module 110, described above. The page configuration module 140 defines a default hierarchy within a group, for example, Geography/Machine type/FRU, as noted in the above table. This hierarchy results in a two-dimensional multi-block display associated with the layer presented as a page such as is illustrated in FIGS. 2 and 3 for different layers. For example, in FIG. 2, “Latin America” appears as a selector attribute 220 within the Geographies group, with blocks corresponding to particular geographies (in this case, the leading dimension in the group hierarchy) and each block comprises rows corresponding to Machine types and columns corresponding to FRUs. The row and column matrices of each block are populated by markers (in this case, in the form of icons) having different visual properties or attributes (e.g. shape, color, blinking, background color and the like) reflecting respective marker properties as determined by the results of various analyses. Such a display, developed by the page configuration module, as will be explained in more detail below, enables a user such as an interface developer using the tool to establish certain marker properties and behavior of the page with respect to actions of an end user of the custom application through a marker configuration module 145.

The function of the marker configuration module is to provide user selection of how the visual attributes of markers (e.g. shape, color, blinking, background/visibility, and the like) and behaviors (e.g. tool-tip, associated text, comment, set of actions, associated vector of values including anticipated RCs, responses to various user action such as single and double clicks and the like) relate to the state of various analyses corresponding to a given combination of selected attributes. A marker can thus also be viewed as a multi-valued function of properties of analysis results including the properties of other markers such as those nested below a given marker in the hierarchy of attribute groups. Thus the function of the marker configuration module 145 allows the user to develop a function defining correspondence between data or results of analyses and the attributes and behaviors of markers. To facilitate this function, a library of functions is preferably built into the IBT to implement these relationships. For example, when the marker configuration module 145 is activated from inside the page configuration module 140 corresponding to a particular attribute combination such as the customer type/machine type/FRU combination of FIG. 3, the user may specify that markers will appear as stars and their properties and behaviors.

For example, upon activation of the marker configuration module, the marker symbol can be defined as a six-pointed star (either-globally or to vary with return codes or the like). The color may also be defined as a specified function of return codes (RC) of analyses of attributes of that level and/or levels nested beneath it such as any non-zero return code is indicated by a red marker color which is otherwise green or more complex functions associating particular colors with particular non-zero return codes or combinations thereof. visibility may be defined by freely selectable background colors. The user can also specify, for example, that a single click of a mouse associating a cursor with a particular marker will report tables of nested analyses accessible by URLs in the attribute table discussed above and a double click will report similarly accessible plots of nested analyses. Other visual attributes and behaviors may also be freely defined such as a tool-tip to display, for example, overall product volumes, identifications and return codes of corresponding nested analyses. Functions can also be set up that compute marker properties based on similar or related properties of other (generally nested) markers.

While such a function of the marker configuration module 145 is highly flexible, it can be implemented quite simply as, for example, a look-up table populated with default values which can be readily changed under user control and which are accessible in accordance with return code values. Other expedients will be readily apparent to those skilled in the art.

Since the marker configuration module 145 is activated from within the page configuration module 140, the page can also be configured such that selection of a marker leads to a display associated with a group of intermediate attributes nested within the attributes corresponding to the selected marker. The page can preferably be configured using a selection-consolidation module 147 that establishes how the marker properties are computed. This feature of the invention is supported by the page control module 140 and enables an end user to select a “cube” of attribute values (e.g. a triplet of groups of attributes; “layers”, separated in accordance with a freely selectable group of the triplet, which are displayed as blocks or sparse matrices 310, 320 of markers as in FIG. 3) and to perform or obtain a consolidated analysis where selected values of an attribute are treated as single values. This type of process allows selective elimination or collapsing of a dimension of the data represented. In terms of the display, such consolidation reduces a plurality of blocks 310, 320 of markers to a reduced number or blocks or single block of markers as may be desirable for screening data to determine where an anomalous value occurs. Hence, the process of consolidation is sometimes referred to as consolidating out a dimension.

The selection-consolidation module 147 also determines how the properties of markers and triggers are combined and established when consolidation is is performed. All pages nested under a page where consolidation is performed are also recomputed. Such a recomputation could be performed by a process in which the DPE formulates an analysis request against the source database 401 if the DPE supports such requests. Alternatively, recomputation can be at least partially performed based on repository 403. A typical entry in the selection-consolidation module would be:

Allow consolidation by: Customer type

Consolidation marker properties:
Color: Red if any marker is red, otherwise green
Shape: Triangle if any marker is triangle, otherwise six-pointed star
RC: Function_Marker_Consolidate
   and so forth. Here it is assumed that Function_Marker_Consolidate is part of the library of functions alluded to above and is capable of generating a return code corresponding to a consolidated marker (e.g. corresponding to a group of attributes based on the constituent return codes for individual attributes of the group).

For example, two-Geography blocks can be selected and consolidated under user control by complete recomputation or by a simpler on-demand procedure (e.g. averaging) on the source data or a procedure based on contents of a results repository (e.g. memory 120) only.

All nested markers are recomputed by the selection-consolidation module 147 in accordance with pre-established rules which are provided as part of an IBT library preferably implemented in memory 120 or the analyses selection module 130. Some rules of general utility including “consolidating out” some dimensions, such as consolidating FIG. 3 into two categories such as banking+retail and other which would reduce the number of blocks from three to two, are preferably provided as part of the IBT. However, it is preferably provided that a designer may supplement this library with other custom rules. These rules are later propagated into the interface building program (IBP). The data processing engine (DPE) 135 must be able to establish processing parameters for a consolidated data stream on-the-fly and the selection-consolidation module preferably establishes the parameter selection method. If the data processing engine 135 provides procedures for establishment of parameters for analysis of consolidated data process parameters, then the selection-consolidation module 147 could specifyu one of these procedures and request the DPE to perform a corresponding analysis. In many cases, however, the interface is not expected to be able to activate the DPE on demand. In such a case, the selection-consolidation is done by consolidating analyses, tables, reports, plots and the like which are already residing in the DPE output repository. A simple method for this purpose is to specify averaging of parameters of the groups selected for consolidation. Under such a consolidation technique, parameters selected for processing of consolidated data streams are selected as the average of constituent parameters. Such a process is preferably reversible, allowing return to a default display.

An exemplary two-dimension block display page is shown in FIG. 2. Two selector attributes 220, 230 are selected preferably by pull-down menus, familiar to those skilled in the art, at the upper right corner of the page, in this case Geography and Ship Vintage which may be fields of a table such as that described above. Additional information such as a date may be applied to the display as desired. The block display 210 comprises columns corresponding to different “Brands” and rows corresponding to different components, the first two fields of the above table as a default. It should be understood that the end user of the interface cannot change the hierarchy although the user of the interface building tool (IBT) of the invertion (e.g. the interface designer may do so. The end user, however, may navigate the interface moving from layer to layer and can change the value of a selector attribute (e.g. Geo) to obtain display of alternate but parallel data but cannot replace a selector attribute with another (e.g. intermediate or terminal) attribute. Columns and rows can be interchanged and/or other fields may be specified by a user for either rows or columns using the page configuration module as discussed above. This type of display enables representation of a potentially sparse matrix of information corresponding to particular pairs of intermediate (or terminal) attributes in a visually economical way on a computer screen, taking advantage of the fact that column and row characteristics can easily be established and communicated using a tool tip display overlaid thereon. Every such two-dimensional display in accordance with the invention is, by definition, a partially condensed display since the information nested under each marker is condensed into the marker and, in accordance with a preferred form of the invention, also because the markers are row-dependent. (For example, the columns of FIG. 3 correspond to FRus of which there may be very many and which may not have attributes corresponding to all rows, either because the FRU may not have a corresponding attribute or if an attribute having a nominal value is suppressed; leading to potential ambiguity, potentially causing the display to be very wide.) Instead, the columns are preferably labeled “All”, “1”, “2”, “3”, . . . and the (e.g. collective) meaning of the (in this case) numeric labels is allowed to vary from row to row and the meaning of the column or identification of parts (in this case) FRUs corresponding to the row entries identified by a tool-tip 340 or the like which can be displayed with the marker. Thus the display can be made relatively narrow because, in general, there are only a few parts such as FRUs that correspond to any given row while the parts contributing to the marker can be easily and unambiguously identified. By the same token, markers provide a convenient and intuitive mechanism for access to information nested under the marker. These forms of partial condensation of the display can be used alternatively or in combination and other techniques suitable for partial condensation of data separately or in combination with either or both of these preferred techniques in a display will be evident to those skilled in the art.

The properties of the marker are partially predetermined such as the configuration of an icon or other shape such as a star, and partially inherited from attributes nested beneath it whether intermediate or terminal. The particular inheritance of properties is defined by relationships referred to as functions. For example, a function could require the color of the marker be red if any marker for a pair of intermediate attributes nested below it is also red. (It is contemplated that, for example, red could indicate information of high interest in regard to a number or particular types of reported failures, yellow could indicate an intermediate level of interest for the same reason or of interest in regard to a different parameter.

The page configuration module 140 also provides for the setting of criteria for inclusion of markers in the display. By default, the layout is determined automatically, based on analysis of the input data. However, it could be requested, for example, to exclude markers based on return codes (RC) or other criteria. For example, the designer could enable the user to change the property of all markers corresponding to RC=0 (“good” return code) as invisible, enable the end user to select only certain machine types, or to set a property of markers to “blinking” when a particular criterion is satisfied. The page configuration module 140 also provides for additional user-initiated actions, such as by switching to a non-default, within-group hierarchy, activation of selection rules, activation of “refine by” capability which results in on-demand expanding of the group of attributes in a layer. For example, if the analysis is by FRU and each FRU corresponds to several part numbers, this capability will produce an analysis by part numbers. Similarly, activation of an “attribute replace” capability results in “on-demand” replacing of layer attributes with other attributes and recomputation of the set of markers for the current layer and any layer(s) nested below it.

The global controls module 150 establishes global processing parameters and global selections, based on selection attributes, discussed above. For example, Type of Analysis or Geography can be designated by the designer/IBT user as a selection attribute. Global controls are also used to establish global marker properties such as forcing all markers for which RC>−30 to have a blink property turned on or forcing all machine types below 6000 or 6*** to be dropped from analysis and display or select from a list of profiles corresponding to, for example, various classes of users. Global trigger properties can also be established to control external actions such as causing a report to be compiled if any of the pages are indicative of wearing out of a part. This global control module 150 module also contains security control arrangements and management of various classes of users.

Essentially, the global controls module provides control of the display of the output of the page configuration module 140 as well as providing some control to the data processing engine 135 which, in turn, selects data and computes analyses for input into the page configuration module. The global controls module is also the point at which controls for self-testing of the interface are applied to the interface being constructed. Self-testing involves the generation of artificial data based on metadata descriptions to create artificial instances of the analyses which, in turn, creates an artificial environment for a designer that emulates the interface which will be generated and thus allows emulation of end user experience. This allows the designer to interact with an emulation of the interface prior to deployment of the actual interface or even creation of interface building program (IBP) which will create the interface as defined using the IBT.

Thus it is seen that the above processes are sufficient to the development of an interface builder program (IBP) since the above processing allows an interface designer to discriminate and organize the available data, provide for computation of analyses and organize the display to communicate partially compressed data and to access underlying data such that an interface in accordance therewith can be navigated flexibly and intuitively by an end user once the interface is actually built and deployed. The IBP is then forwarded to a communication module 160, preferably stored with the application and production data 180 in a data repository storage 170 and the application run using the interface as depicted at 190 of FIG. 1.

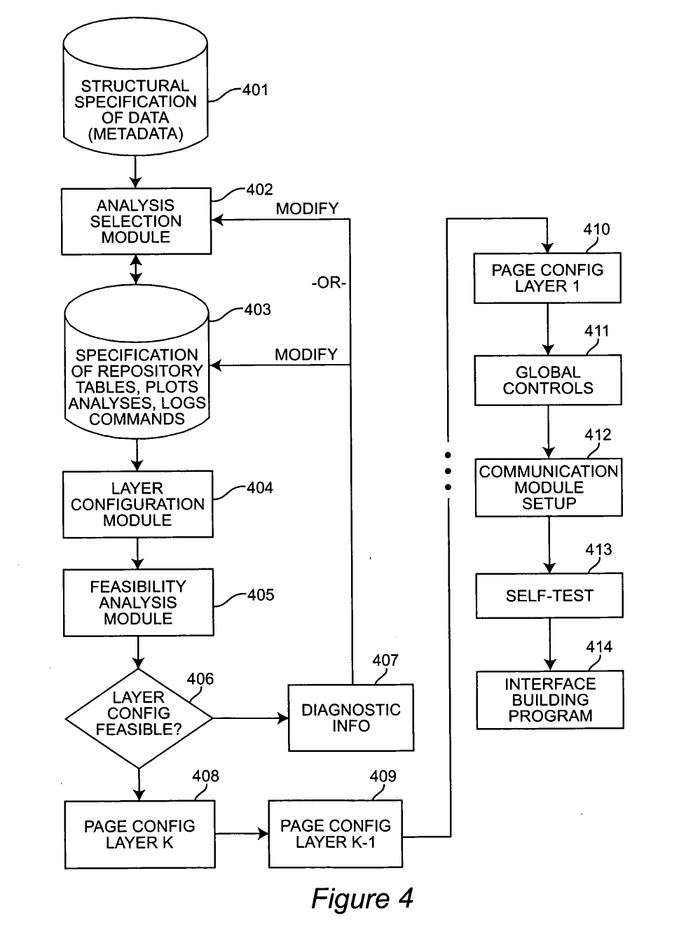

Referring now to the flow chart of FIG. 4, operation of a preferred embodiment of the basic architecture of the invention discussed above in connection with FIG. 1 is illustrated. The process begins with step 401 which provides a structural specification of a database preferably similar to a serial file which contains information regarding parts as metadata. Step 402 provides this information, as selected via control of the data processing engine 135 to the analyses selection module 130. The data processing engine communicates with the database 120 to produce analyses, tables plots, reports and the like sorted by commodity data. The data processing engine 135 is assumed to produce a repository of analyses that drives the IBT. The IBT works from the metadata descriptions of these analyses. Again, actual data is not needed and this process may be performed using metadata. The results are stored (403) in a database such as 120 and are also consider and treated as attributes (albeit of derived type). A database layout or directory structure containing this information is also specified at this point. The repository maintains an index of attributes corresponding to a given part which also specifies (404) whether the attributes can be used as selection, intermediate or terminal attributes via the layer configuration module 110. If a particular specified combination of attributes does not provide meaningful information, the process branches and loops (107) back to step 402 or 404 via diagnostics which modify either the analyses applied or the layer configuration to assure that the layer configuration is feasible, as discussed above. If the configuration is not feasible, the diagnostics report is used to establish whether the DPE could produce the missing information. A two-way communication with the analyses selection module is established and results in modification of the layer configuration or modification of analysis selections. If the layer configuration is feasible, page configuration module processing as described above is performed at step 408. This module is activated for every group of intermediate attributes, starting from the first layer that depends on terminal attributes only, by default. The operation of the page configuration module 140 will be described in greater detail below in connection with FIG. 5. This process then iterates through all layers of intermediate attributes (e.g. step 409) until completed by processing, at step 410, of the highest or first layer of intermediate attributes below the selector attributes.

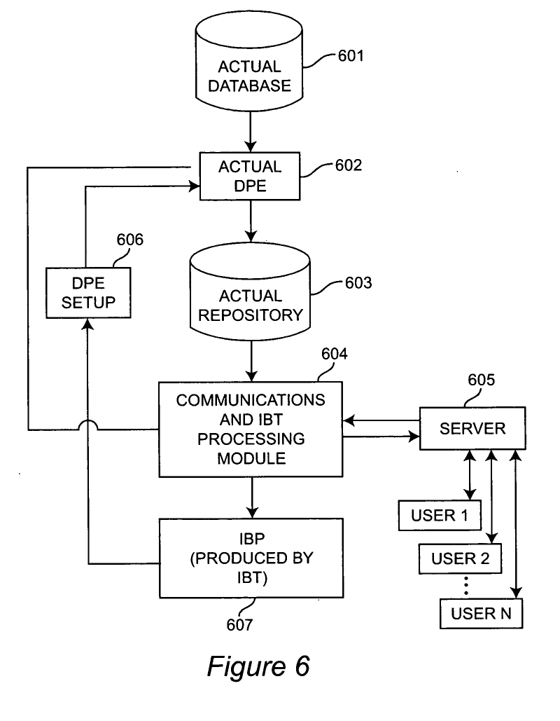

The results of this processing are then further processed, at step 411, by the global controls module 150 as described above. The process then continues with setup 412 of the communications module which contains user management, data processing engine control for scheduling, caching, web server management, update, backup and recovery procedures. It is preferred that some of the plots, reports and the like are kept on the web server while others remain at the repository 603 (generally corresponding to storage 170 of FIG. 1) which will be described below in connection with FIG. 6. It should be appreciated that storage 120 of FIG. 1 describes all the analyses in terms of metadata and thus serves to drive the IBT which can emulate the interface. In contrast, repository 603/170 is the actual repository of data corresponding to output of DPE 135 which drives the interface, once deployed. Once the communications module is properly operational, the result of the global controls module processing is forwarded to a self test module 155 for simulation (413) of the actual data based on the metadata to let the interface designer view the emulated performance of the interface. Alternatively, if access is provided to the data processing engine 135, simulation could be performed based on metadata directly obtained from repository 120. If the interface performance is acceptable, the parameters developed by the page configuration module 140 and the global controls module are forwarded for processing by IBP software executable, when activated by the administrator, that builds an interface program that performs linking of the interface to the actual data from the production data repository 170/603, activating the data processing engine 135, establishing lists of users and categorizing them and activating the interface by opening communications to end users. It should be noted that the administrator/designer does not build the IBP or the interface but need only activate an IBP using the information derived from metadata with selected analyses, page and marker configurations and global controls to produce a program that actually implements the interface for a particular data processing environment.

Referring now to FIG. 5, the operation of the page configuration layer will now be explained in detail. This process preferably operates on only one layer of intermediate attributes at a time and may process layers in any order as indicated at step 500. The process then transfers the attributes of a given layer to a marker configuration module as indicated at step 501. This module reflects the state of analysis corresponding to a given combination of selected attributes which are selected at 404-407 of FIG. 4. The (graphic) properties of the marker such as shape, color, tool-tip, associated text, comment, set of actions, associated vector value (e.g. RC), prespecified responses with user's actions, visibility and the like are established in this module. The marker can thus be viewed as a multi-valued function of properties of other markers, typically those nested below it in the attribute level hierarchy. A library of functions is preferably built into this tool to implement the relationships of underlying attributes/markers to the visual attributes of the marker at the current level.

The results of this processing is then (optionally but preferably) transferred to a trigger configuration module as indicated at 502. Triggers are functions that map the properties of the markers onto a set of actions, such as producing a report. Some triggers may be functions of individual markers or a combination of markers. Provision is preferably made for triggers to be propagated to other layers to avoid the need to define each marker at each level; the number of which in a single level can be quite large and the number of possible levels is arbitrary. The processing then establishes a default hierarchy of attribute corresponding to a page and the current attribute level as depicted at 203. For example, if the intermediate attributes of a given layer are Geography-Machine Type-FRU, in that order, then the partially condensed display will comprise, for example, a set of blocks (e.g. 310, 320 or FIG. 3) corresponding to Geos (first dimension) with every block comprising a set of rows corresponding to machine types (second dimension) and condensed columns labeled All, 1, 2, 3, etc. for respective FRUs (third dimension). The processing of the page configuration module is completed with processing 504 by a page controls module supporting controls for the interface user such as selection, consolidation, computation and “refine by” capability as discussed above.

Referring now to FIG. 6, deployment of the invention will now be explained. As indicated above, prior to such deployment, the invention preferably exists in software since at least metadata in accordance with a particular (custom) application and the applications a (custom) application is intended to manage is required for an appropriate interface to be developed for the particular (custom) application. The interface is then built, viewed (by emulation), refined and tested as discussed above. At the time of deployment, the (custom) application will have been completed but for the interface and actual data will exist in repository 601 and well as repository 603 containing actual derived tables, plots, analyses, log books, commands and the like developed based on metadata. These repositories will now be associated with the actual data processing engine (DPE) 602 on which the (custom) application is to be run and on which a communications module 604, an interface building program (IBP) 607 as developed by the invention and a DPE setup module will have been installed. The communications and processing module 604 is also preferably connected to a communications or web server supporting communications with users.

In this configuration, the DPE 602, having been set up by the DPE set up 606 module under control of the interface building module 607, communicates with repository 601 to produce tables, plots, reports and the like as discussed above but now based on actual data (e.g. 180 of FIG. 1). These derived attributes can be sorted as desired and various combinations can be flagged. These derived attributes are stored in repository 603 (which may or may not be the same physical device as 601) and the repository is automatically set up by control of the DPE 602 from the interface building program 607 based on the specification developed during the design phase using metadata as discussed above in connection with FIG. 4. The communications interface server is also set up by the interface building program (produced by the IBT) in order to communicate with end users including delivery of menus, information and the like and accept user input in accordance with the interface function. The communications and IBT processing module is also set up by the interface building program 607 in order to establish communications with the server, the DPE and repository 603, perform processing of data in repository 603, conduct user management, access, update and backup activities and enable run time system administration. Once the set up of the interface is complete, the interface building program is disconnected, leaving behind a fully operational interface corresponding to the (custom) application. Subsequent maintenance and modifications are performed through the communications and processing module 604.

In view of the foregoing, it is seen that the invention provides for automated design, building and testing of an interface for an arbitrary application having arbitrary data based only on descriptions of the data in the form of metadata. The interface is then automatically built from specifications derived using the metadata during deployment to deliver a fully functional interface virtually upon completion of the (custom) application while the amount of time and effort required of the interface developer is substantially limited to determination of the visual characteristics of the markers used in the partially condensed displays and supervision of self-testing while the actual generation of code is automated substantially fully. Moreover, while fully generalized for use with any arbitrary application, the markers and display format are highly intuitive for an interface for locating data of interest and performing manipulation of data, computation and compiling of plots, tables and reports and the like using such an interface while the appearance thereof to communicate information to a user. The interface builder in accordance with the present invention enables production of a list of attributes including methods and analyses, categorization of such attributes (specifying a hierarchical structure among groups of attributes), configuration of display pages related to individual groups, specification of the functions and triggers related to markers, produce and test an interface and produce an interface builder program as an output which builds a working interface automatically upon deployment. The tool may be used in a stand-alone mode or as part of another application.

While the invention has been described in terms of a single preferred embodiment, those skilled in the art will recognize that the invention can be practiced with modification within the spirit and scope of the appended claims.

1. A method of creating an interface for an arbitrary application program, said method comprising steps of
parsing a description of data to determine attributes of a plurality of objects,
partitioning said attributes into groups,
establishing a hierarchy among attributes of at least one said group of attributes,
providing analysis formulas for computing values of attributes from attributes lower in said hierarchy, and
establishing visual characteristics of markers corresponding to values resulting from said computing of values in accordance with said formula.

2. A method as recited in claim 2, including a further step of
establishing properties of markers for controlling access to data nested under a said marker.

3. A method as recited in claim 2, wherein said access to data accesses a plot of data corresponding to said marker.

4. A method as recited in claim 2, wherein said access to data accesses a table of data corresponding to said marker.

5. A method as recited in claim 2, wherein said access to data is performed in accordance with a network address.

6. A method as recited in claim 2, wherein said access to data accesses a return code.

7. A method as recited in claim 1, including a further step of evaluating feasibility of said hierarchy.

8. A method as recited in claim 7, including a further step of modifying one of said hierarchy and a selected one of said analysis formulas.

9. A method as recited in claim 1, wherein a said marker represents a partially condensed display of data or data analysis.

10. A method as recited in claim 9 wherein data nested under a marker is selected by selection of a marker.

11. A method as recited in claim 9 wherein data or parts corresponding to a marker is displayed with said marker.

12. A method as recited in claim 1, including a further step of establishing a trigger.

13. A method as recited in claim 12, including a further step of performing a selected data analysis in response to a said trigger.

14. A method as recited in claim 1 including further steps of
consolidating attributes of a group of attributes to obtain consolidated attributes, and
performing an analysis of said consolidated attributes.

15. A method as recited in claim 14 wherein said step of performing an analysis of said consolidated attributes includes averaging or estimation.

16. A method as recited in claim 14 wherein said step of performing an analysis includes recomputation of attributes of pages nested under a page where said consolidating step is performed.

17. A machine-readable storage medium having a program stored thereon which is executable by a data processor, said program, when executed on a data processing apparatus performing steps of
parsing a description of data to determine attributes of a plurality of objects,
partitioning said attributes into groups,
establishing a hierarchy among attributes of at least one said group of attributes,
providing analysis formulas for computing values of attributes from attributes lower in said hierarchy, and
establishing visual characteristics of markers corresponding to values resulting from said computing of values in accordance with said formula.

18. A machine readable storage medium as recited in claim 17 wherein said program performs a further step of
establishing properties of markers for controlling access to data nested under a said marker.

19. A machine-readable storage medium as recited in claim 17 wherein said program performs a further step of evaluating feasibility of said hierarchy.

20. A machine-readable storage medium as recited in claim 17, wherein a said marker represents a partially condensed display of data or data analysis.

21. A machine-readable storage medium as recited in claim 17, wherein said program performs a further step of establishing a trigger.

22. A machine readable storage medium as recited in claim 17 wherein said program performs further steps of
consolidating attributes of a group of attributes to obtain consolidated attributes, and
performing an analysis of said consolidated attributes.

23. A computerized interface building tool including
means for parsing descriptions of data to be managed by an application through use of said interface to develop a categorization and hierarchy for attributes of said data as defined by said descriptions,
means for defining analyses of data in accordance with said categorization and hierarchy,
means for defining visual attributes and properties of markers of a display, and
means for outputting said categorization, hierarchy, analyses and properties to derive an interface building program.

24. A tool as recited in claim 23, wherein said hierarchy is a user-defined hierarchy and said tool further includes
means for determining feasibility of said user-defined hierarchy.

25. A tool as recited in claim 23 wherein said display forms a partially condensed display.

26. A tool as recited in claim 25 wherein data nested under a marker is selected by selection of a marker.

27. A method as recited in claim 25 wherein data or parts corresponding to a marker is displayed with said marker.
